(19) United States
(12) Patent Application Publication
(10) Pub. No.: US 2018/0308122 A1
(43) Pub. Date: Oct. 25, 2018

(54) System and Method of Distributed Marketing and Commerce through Social Media Communications

(71) Applicants: Ami Rebecca Moore, New York, NY (US); Tim Rodgers, New York, NY (US)

(72) Inventors: Ami Rebecca Moore, New York, NY (US); Tim Rodgers, New York, NY (US)

(21) Appl. No.: 15/959,757

(22) Filed: Apr. 23, 2018

Related U.S. Application Data
(60) Provisional application No. 62/488,580, filed on Apr. 21, 2017.
(60) Provisional application No. 62/592,153, filed on Nov. 29, 2017.

(51) Int. Cl. G06Q 30/02; G06Q 30/06

(52) U.S. Cl. CPC G06Q 30/0242; G06Q 20/12; G06Q 30/0635; G06Q 30/0605

(57) ABSTRACT

Methods, systems, and software for monitoring users' interactions with external media and initiating purchase transactions without interrupting the users' interactions with the external media, and permitting transactions with multiple retailers via stored associations between one or more products and one or more items of digital content.

### CROSS-REFERENCE TO RELATED APPLICATIONS

This application claims priority to U.S. Provisional Application No. 62/488,580, filed on Apr. 21, 2017 and U.S. Provisional Application No. 62/592,153, filed on Nov. 29, 2017. The contents of both of these provisional applications is hereby incorporated by reference into this specification.

### FIELD OF THE INVENTION

The invention relates to the field of e-commerce. More specifically, embodiments of the invention relate to systems and methods of conversational e-commerce and digital content related to retail products, services, and experiences.

### BACKGROUND OF THE INVENTION

For brands that sell products and services online, it is increasingly difficult to advertise to consumers. Blocking technologies restrict the display of advertisements on websites, mobile apps, social networks and the internet, and there has been a shift in consumer behavior from using the internet or mobile applications on their desktops and mobile devices toward using conversational interfaces, such as chatbots, messaging, voice messaging, and others. It is relatively more difficult to display advertisements on modern opt-in digital platforms like conversational interfaces, including chatbots, messaging, voice messaging, VR and AR style technologies. Those systems typically prevent advertisements until a consumer has invited advertisers to connect with them.

One way that brands have engaged consumers in recent years is product placement using celebrities or other persons with large exposure on social media platforms and the internet. Such individuals achieve a certain amount of fame online and are often referred to as “influencers.” It is commonly understood that influencers typically have followings of more than one hundred thousand users on such social and internet networks as Instagram, YouTube, Twitter, and other media platforms. As used in this specification, the term “external media” or “external medium” refers to any site, application, or service that provides and/or permits the publication of digital content of any kind by its users. Examples of “external media” include, without limitation, any social media applications and individual websites, like blogs, vlogs, online diaries, Kik, Facebook Messenger, Snapchat, Twitter, Pinterest, Facebook, Instagram, Google+, Sharethis, WhatsApp, Viber, Telegram, Signal, Wire, Line, WeChat, Google Hangouts, Google Allo, Google Assistant, Silent Circle, Tumblr, Mobile QQ, Momo, Wangxin, Youni, YouTube, Vine, and Flickr.

Brands provide payment to influencers in return for media, comments, or content being created to promote the brand online. In recent years, problems have arisen with respect to this model. For example, the most successful influencers (i.e., those with large followings) are becoming hard to manage and expensive to engage, as they arguably have widespread reach due to the high number of followers. This creates a substantial financial burden on many brands. There is also significant logistical and financial strain on brands who engage numerous influencers to promote their products.

For influencers, it can be difficult to generate significant revenue from their posts because of the large amount of competition from other influencers. Additionally, many influencers can struggle with developing product lines, e-commerce software, and obtaining publishing support. In addition, the platforms that exist in the marketplace require substantial vetting of prospective influencers, which brings additional complexity to influencers being able to generate revenue.

From the perspective of consumers, it is advantageous to have brands, users, influencers and publishers creating content on external media, because of the large amount of exposure to products, styles, methods and trends. However, it is difficult for consumers exposed to this abundance of content to find and purchase the products included therein.

The platforms currently available by which consumers can purchase products and/or services via mobile applications, email and webpages are less than optimal, as they disrupt the existing consumer behavior flow. For example, when a consumer observes a product in an Instagram post that he or she is interested in purchasing, clicking on a link associated with that product interrupts the consumer's use of Instagram by requiring the consumer to engage with a retailer's website or application in order to complete purchase of the product. This discourages consumers from initiating the purchase process, as consumers may not be ready to discontinue review of content on Instagram. The situation is the same for other types of external media.

The consumers' reluctance to disengage from external media in order to pursue purchase of products being promoted on such media is a problem unique to the technological environment in which brands/retailers now compete for e-business.

Additionally, currently available solutions do not enable consumers to purchase products from multiple brands in a single transaction. Instead, consumers are required to complete multiple transactions via multiple different websites, applications, etc. if they wish to purchase products from multiple brands and/or retailers. This often requires the consumer to create and remember multiple sets of login criteria and other information that is specific to each brand/retailer. This is another unique problem in this technological environment.

Accordingly, it is desirable to provide systems and methods that allow brands to more efficiently expose their products to consumers and thereby increase their sales, that allow influencers to generate revenue featuring brands in their content, and that allow consumers to easily purchase products from content, media, comments, audio and text, while not disrupting a consumer's typical engagement with websites, applications, etc. It is also desirable to provide a system and method that allows consumers to more efficiently purchase products from multiple retailers.

### SUMMARY OF THE INVENTION

Therefore, it is an object of the present invention to provide methods and systems that allow consumers to shop multiple products from multiple brands/retailers without disrupting the consumer's normal interaction with a particular application.

It is yet another object of the present invention to provide methods and systems that monitor a consumer's online activity and allows consumers to purchase from multiple brands/retailers in a single transaction.

It is still another object of the present invention to provide methods and systems that improve influencers' abilities to promote the products of multiple brands/retailers simultaneously.

It is still another object of the present invention to provide methods and systems that interact with consumers through use of a conversational commerce or chatbot functionality.

In order to at least partially achieve these objectives, embodiments of the present invention are provided, which include computer implemented methods practiced on a set of one or more devices, each comprising at least one processor; systems comprising a set of one or more processors and a computer-readable medium storing instructions executable by the set of one or more processors to perform operations; and non-transitory computer-readable media, storing instructions executable by a set of one or more processors to perform operations. Embodiments of the present invention comprise steps or instructions to perform operations for:

registering a first user, including receiving data to permit monitoring engagement with a first external medium by an account of the first user at the first external medium;
receiving product data regarding a set of one or more products from one or more retailers;
storing, in a database, an association between at least one product from the set of one or more products and at least one item of digital content for publication on the first external medium;
querying an application programming interface of the first external medium on a periodic basis regarding data related to a first user's engagement with the at least one item of digital content on the first external medium;
receiving, from the application programming interface of the first external medium, first data indicating at least one positive interaction with the at least one item of digital content by the first user; and
transmitting data to the first user related to completing purchase of the at least one product from the set of one or more products in the association via an interface separate from the first external medium so that the first user's engagement with the first external medium is not interrupted.

In some embodiments, the step/operation of receiving product data comprises:

receiving first product data regarding a first set of one or more products from a first retailer; and
receiving second product data regarding a second set of one or more products from a second retailer;
and wherein the step/operation of storing an association comprises:
storing a first association between the first product data and the second product data to form a first look; and
storing a second association between the first look and the at least one item of digital content.

In some embodiments, the step/operation of transmitting data to the first user related to completing purchase further comprises transmitting requests to the first user to purchase products in the first and second sets, and wherein the separate interface comprises a messaging application; and additional steps/operations include:

receiving first purchase data regarding the first retailer;
receiving second purchase data regarding the second retailer;
receiving first payment data regarding the first user;
receiving one or more requests from the user, via the separate interface, to purchase at least one product in the first set and at least one product in the second set;
completing a first transaction with the first retailer using the first payment data and the first purchase data to purchase at least one product in the first set on behalf of the first user; and
completing a second transaction with the second retailer using the first payment data and the second purchase data to purchase at least one product in the second set on behalf of the first user.

In some embodiments, additional steps/operations include:

registering a first influencer, including receiving data related to an account at the first external medium associated with the first influencer;
identifying the first influencer via the first data indicating at least one positive interaction with the at least one item of digital content received.

In some embodiments, the step/operation of creating an association comprises:

storing, in a database, a first association between at least one first product and at least one first item of digital content for publication at the first external medium;
additional steps/operations include:
storing, in a database, a second association between at least one second product and at least one second item of digital content for publication at the first external medium;
the step/operation of querying an application programming interface comprises:
querying an application programming interface of the first external medium on a periodic basis regarding data related to the first user's engagement with the at least one first item of digital content and the at least one second item of digital content in the first external medium;
the step/operation of receiving first data indicating acceptance of the at least one first item of digital content comprises:
receiving first data indicating at least one positive interaction with the at least one first item of digital content by the first user from the application programming interface of the first external medium; and
additional steps/operations include:
receiving second data indicating at least one positive interaction with the at least one second item of digital content by the first user from the application programming interface of the first external medium.

In some embodiments, the step/operation of transmitting data to the first user related to completing purchase further comprises:

transmitting data to the first user related to completing purchase of the at least one first product via a messaging application in the first association separate from the first external medium so that the first user's engagement with the first external medium is not interrupted; and
transmitting data to the second user related to completing purchase of the at least one second product via the messaging application in the second association separate from the first external medium so that the first user's engagement with the first external medium is not interrupted.

In some embodiments, additional steps/operations include:

registering a first influencer, including receiving data related to an account at the first external medium associated with the first influencer;
identifying the first influencer via the first data indicating at least one positive interaction with the at least one first item of digital content received and/or via the second data indicating at least one positive interaction with the at least one second item of digital content received.

Accordingly, by provision of systems and methods with the capability of tracking “looks,” or the associations created between products and digital content, as well as consumers' interactions with those looks on external media, streamlined purchase of those products by the consumers is achieved without interrupting the consumers' interaction with the external media.

Additionally, by provision of systems and methods that streamline transactions with multiple retailers, consumers and retailers can more efficiently complete purchase transactions.

Other features and aspects of the invention will become apparent from the following detailed description, taken in conjunction with the accompanying drawings, which illustrate by way of example the features in accordance with embodiments of the invention. The summary is not intended to limit the scope of the invention, which is defined solely by the claims attached thereto.

### BRIEF DESCRIPTION OF THE DRAWINGS

FIG. 1 is a schematic view of a system according to an embodiment of the invention.

FIGS. 2-8 are schematic flow charts showing the steps of a method and the operations of a system according to embodiments of the invention.

FIG. 9 is a schematic view of the relationships between components of a system according to an embodiment of the invention.

FIG. 10 is a schematic view of the components of a ‘look’ according to embodiments of the inventions.

FIGS. 11a-11d show a series of screen shots of an interface by which influencers interact with a system according to an embodiment of the invention.

FIGS. 12a-12b show a series of screen shots of an interface through which users interact with a system according to an embodiment of the invention.

### DETAILED DESCRIPTION OF THE INVENTION

The following description illustrates embodiments of the invention by way of example, not by way of limitation of the principles of the invention. This description will enable one skilled in the art to make and use embodiments of the invention, and describes several embodiments, adaptations, variations, alternatives and uses thereof.

The term “influencers,” as used in this specification unless indicated otherwise, includes any individual, group of individuals, or entity that creates and/or publishes any digital content (as defined herein) that may be associated with any one or more forms of external media (as defined herein) and that may be associated with the products (as defined herein) of any retailer (as defined herein). The terms “influencers” and “retailers” (as defined herein) are not mutually exclusive, in that a retailer may also meet the definition of an influencer and vice versa. The scope of the term is not limited by the number of followers of the influencer or the type of external media used by the influencer.

The term “retailers” as used in this specification includes any individual, group of individuals, or entity that sells or offers to sell any product or service. This includes brands, manufacturers, wholesalers, distributors, and retailers of any kind.

The term “digital content,” as used in this specification, includes any text, images, audio, video, or any other content capable of being published via any form of external media.

The term “product” as used in this specification, unless indicated otherwise, includes any good, service, and/or experience that anyone, including any retailer, may sell or offer for sale.

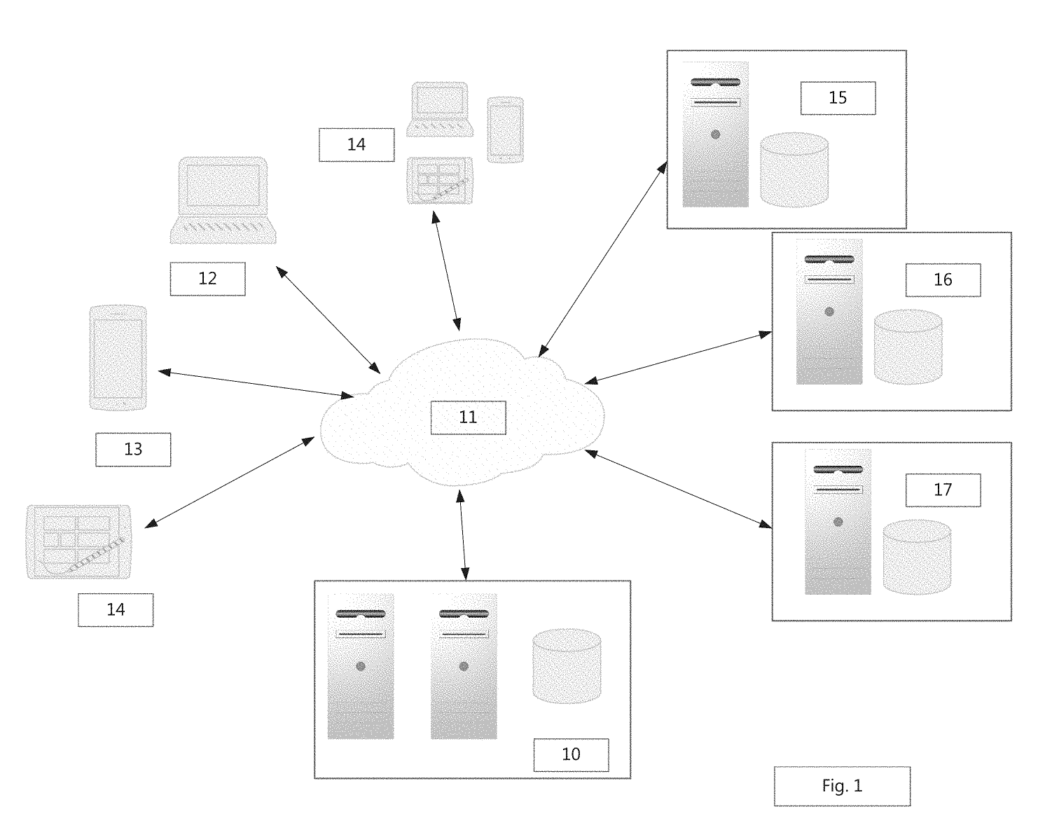

Embodiments of the invention will now be described with reference to the figures. FIG. 1 shows a schematic view of a system according to one embodiment of the present invention. In this embodiment, the system 10 comprises one or more servers and one or more electronic storage devices. In other embodiments, the system comprises other appropriate hardware for performing the functions and tasks described herein. In some embodiments, the software components of the system 10 are stored in cloud storage in various locations.

The system 10 communicates via the Internet 11 with one or more users 12, 13, 14. Users 12, 13, 14 are consumers, and they can engage with the system 10 via any device with access to the system via a network. These include any computers, servers, phones, tablets, etc. In other embodiments, networks other than the Internet 11 link the system with the users and other parties in communication with the system, such as WAN, LAN, MAN, and others. Similarly, the system 10 also communicates with one or more influencers 14, one or more retailers 15, one or more external media 16, and one or more e-commerce platforms 17.

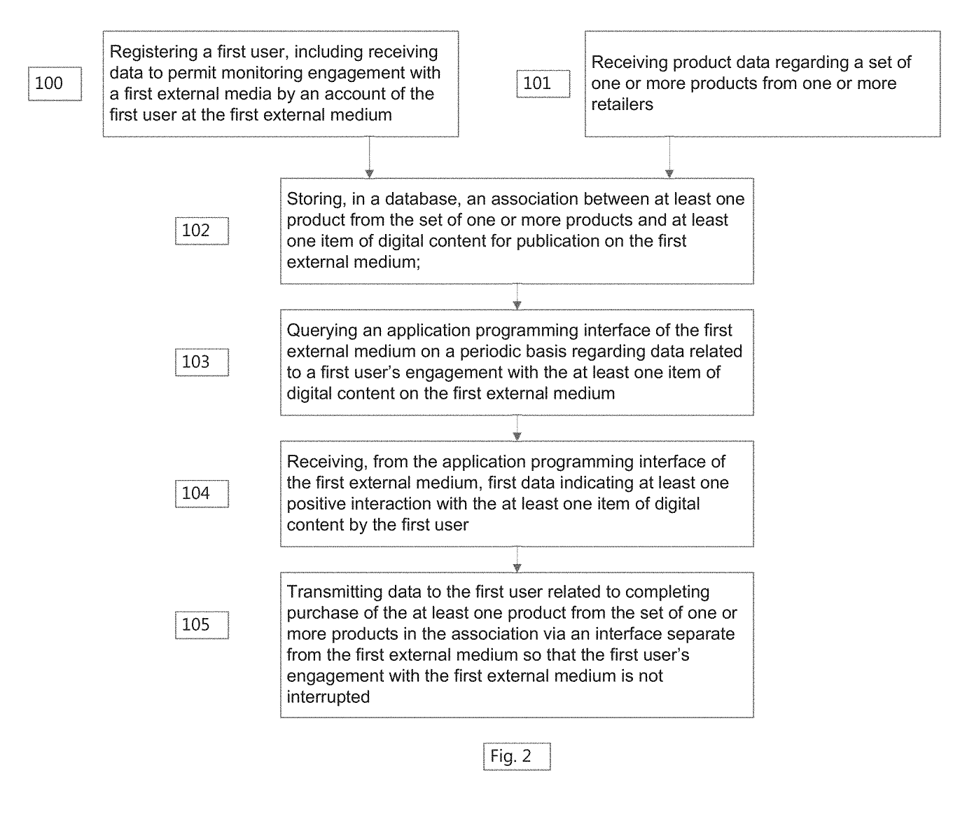

FIGS. 2-8 show flow charts representing the method steps/operations performed by embodiments of the present invention. (For brevity, the steps/operations shown in the flow charts will be referred to herein simply as “steps.”) Those of skill in the art will understand that the illustrated steps are executed via software stored on one or more non-transitory, computer readable media via one or more processors.

At step 100, the system registers a first user, which includes receiving data to permit monitoring engagement with a first external medium by an account of the first user at the first external medium. In some embodiments, users provide data to the system regarding one or more external media accounts, along with payment, billing, shipping, and other related information. In some embodiments this process involves a user profile module or service. In some embodiments, user registration includes the user downloading an application for use on his or her device, which includes smartphones, tablets, laptop PCs, desktop PCs, and any other suitable computer device. In other embodiments, the user can interact with the system via a website loaded on a web browser.

At step 101, the system receives product data regarding a set of one or more products from one or more retailers. In some embodiments, this step includes using the system's administration tools (“admin tools”) so that one or more retailers can register with the system. In some embodiments, registration includes authenticating the retailer's ecommerce store with a store admin tool provided by the system, which will grant the system access to the retailer's product inventory, products, descriptions, and other product-related metadata like images, video clips, etc. In some embodiments, retailers also interact with the system via a system specific application that is either stand-alone or accessed via a web browser.

In some embodiments, the store admin tool provides the retailer with the ability to agree or negotiate affiliate fees on products and/or groups of products with respect to influencers, including formulas to recalculate such affiliate fees when items are at a discount. In some embodiments, the store admin tool provides a way of agreeing on local tax, shipping rates and any other associated variables for the retailer's products to be sold through the platform.

FIG. 3 shows additional steps related to receiving product data in some embodiments. At step 101-1, the system receives first product data regarding a first set of one or more products from a first retailer, and at step 101-2, the system receives second product data regarding a second set of one or more products from a second retailer. In some embodiments, the system pulls product data from an E-commerce platform application programming interface (API). In some embodiments, an E-commerce platform API is hosted by each individual retailer, in other embodiments it is hosted by one or more specific retailers, in other embodiments, it is hosted by the system 10 itself, and, in still other embodiments, by a third party. In some embodiments, product data is pulled by the system automatically upon identification of a product by a retailer. In some embodiments, the products will be displayed in the system's store admin tool giving the retailer the ability to choose which products will be made available to the system to be linked up with digital content. Nevertheless, the system is designed to handle products from any number of unrelated retailers.

At step 102 shown in FIG. 2, the system stores, in a database, an association between at least one product from the set of one or more products and at least one item of digital content for publication on the first external medium. This association is sometimes referred to as a “look.” Typically, influencers create “looks,” which include a combination of one or more items of digital content and data related to one or more products of one or more retailers, in some embodiments. As an example, an association, or “look”, can includes one or more products and one or more pictures, text commentary, captions, video, and/or audio files (i.e., items of digital content). The stored association permits the system to track users' interactions with the digital content and, based on that interaction, complete sales of the associated products.

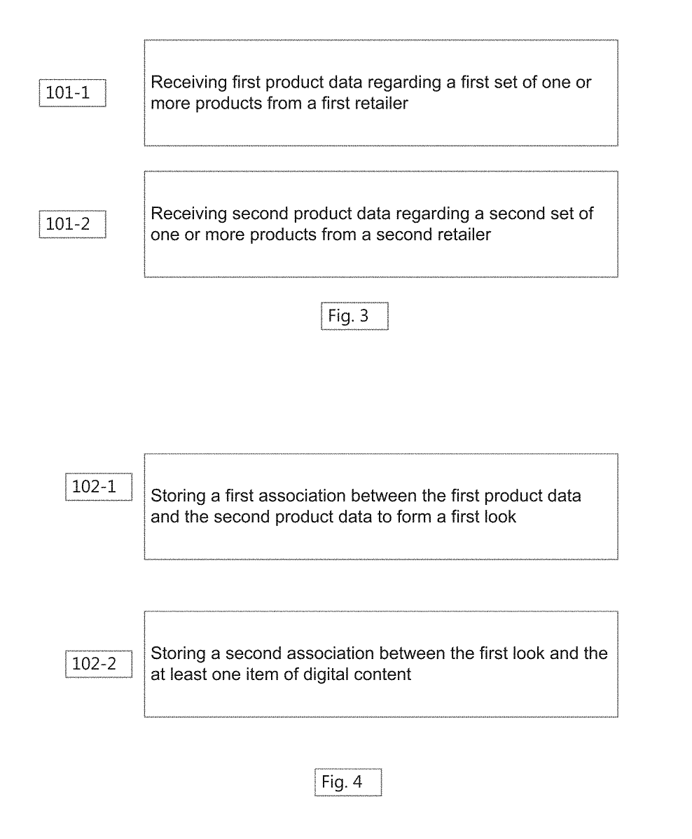

FIG. 4 shows additional steps related to creating the association when products from multiple retailers are involved. At step 102-1, the system stores a first association between the first product data and the second product data to form a first look. At step 102-2, the system stores a second association between the first look and the at least one item of digital content. The system functionality underlying these steps/operations permit products from multiple retailers to be associated together with an item of digital content into a look.

At step 103 shown in FIG. 2, the system queries an application programming interface of the first external medium on a periodic basis regarding data related to a first user's engagement with the at least one item of digital content on the first external medium. As suggested above, the system monitors the user's interaction with the at least one item of digital content that was made part of the association at step 102. In some embodiments, this functionality is performed by what could be called a “listener service.” The “looks” or “associations” identified above are typically saved, and the system will share saved looks with the listener service. The listener service periodically queries each external medium API identified for the user and catalogs the user's interactions with the digital content on such external media. The user interactions with external media include viewing, liking, commenting, or otherwise, depending on the nature of the specific external medium. For example, Instagram permits a user to “like” a posted item of digital content. The listener service would, in some embodiments, track and receive data from Instagram regarding the user's “likes” of digital content.

At step 104, the system receives from the application programming interface of the first external medium, first data indicating at least one positive interaction with the at least one item of digital content by the first user. A “positive interaction” encompasses any positive input from the user regarding the at least one item of digital content, product, etc. This includes, but is not limited to, “liking,” “retweeting,” or otherwise recommending the content. Interaction of any kind is logged by the system in some embodiments, and in some of those embodiments, the system is designed to focus on any positive interaction for further processing. Negative or neutral interactions also have value, however, and in many embodiments these interactions are also cataloged for analysis by the system or its users, influencers, and/or retailers.

In some embodiments, for example, the listener service monitors a user's interaction with content on various different websites and social media platforms, including the user's activity and “likes” on websites such as YouTube and platforms such as Instagram. The listener service receives data regarding this activity via the respective YouTube and Instagram APIs. Specifically, in such embodiments, the listener service monitors endpoints for example: the “Activities: List” endpoint in YouTube API and the “RecentLikes” on Instagram.

In some embodiments, the listener service checks a user's interaction with external media every fifteen seconds, and, in so doing, makes a request to the relevant APIs in order to receive a user's most recent activity and likes. In some embodiments, a request for most recent likes returns a full media object, which includes data about the video or post. In some embodiments, as discussed above, the listener service records every item received from the various APIs, e.g. the YouTube and Instagram APIs, and the items are kept in chronological order on a relational database.

In some embodiments, two lists of “likes” are kept: a permanent record of likes and a rolling list of likes. When a new set of records is received from the various APIs, the listener service saves any records not currently on the permanent list to the permanent list. In such embodiments, in order to keep track of recently liked and unliked posts, the listener service then checks to see if there are any identifications in the new set of records that are not in the most recent likes, and these are added to the list of rolling likes. After this, the listener service deletes any likes that are on the rolling list which were not received in the most recent request.

Based on this data, the system now has information regarding products in which the user is interested. The listener service, as discussed above, has data regarding the association between items of digital content and products that have been identified by retailers. The listener service obtains data regarding users' interest in such products via the likes and other activity of the user as a result of its request to the external media API. In some embodiments, the listener service will send this data to a look-up service in order to check the stock levels of the products with the E-commerce platform API. In some embodiments, the look-up service also retrieves the variants of the products as well as the product information, imagery and associated metadata.

At step 105, the system transmits data to the first user related to completing purchase of the at least one product from the set of one or more products in the association via an interface separate from the first external medium so that the first user's engagement with the first external medium is not interrupted. In other words, when the listener service receives notification that a user has had a positive interaction with one or more items of digital content associated with a saved “look,” the listener service will initiate the process of completing a sale to the user. The system does this without interrupting the user's engagement with the external medium. For example, a user who is perusing Instagram posts can “like” a post that includes one of the “looks”, and the system will log this input via the listener service without any additional input or disruption to the user. The user is able to continue perusing Instagram posts and applying more “likes” as desired. The system transmits the data to the user using an interface separate from the external medium, such as a separate application with messaging capability, a separate web browser window, an email, etc.

In some embodiments, a messaging service is used to accomplish this step. Product data associated with the user's “like” or other acceptance via the external media is transferred to a messaging service to be transcribed into a message intended for the user. The messaging service is adapted to assemble the appropriate language, content, variant of conversation, and text to create a series of messages, which will be queued, ready to be sent to the user. In some embodiments, the messaging service communicates with the user through a messaging application that is specific to the system, such as the downloadable application mentioned above. For example, the system communicates with a dedicated native app on the user's smartphone that includes the functionality to send and receive messages with the system. In other embodiments, the messaging service communicates with the user through an external messaging platform, such as instant messaging, email, Internet Protocol-based messaging applications such as Facebook Messenger, WeChat, Whatsapp, various SMS-type messaging applications, augmented reality messaging application, and numerous others. The messaging service, working with the look-up service will, in some embodiments, suggest alternatives for products that are out of stock or will offer to notify the user when such a product is back in stock. In some embodiments, the system communicates with users via a push notification using a chatbot, messaging application, or voice application as recorded in the user's preferences. User preferences can also dictate the timing of the messaging, (e.g., ASAP, daily, weekly etc.) in some embodiments.

When the message is ready to be sent, the messaging service sends the data directly to the user via the system's messaging functionality or to the API of the external messaging platform, which will deliver the message and conversation to the user. Via the messaging service, the user is able to communicate back and forth with the system to view content, metadata, caption, media, comments, audio and text related to the products of interest.

In some embodiments, if a product of interest is not in stock, the look-up service will send a message to the user through the messaging service to inform the user that the product is not available.

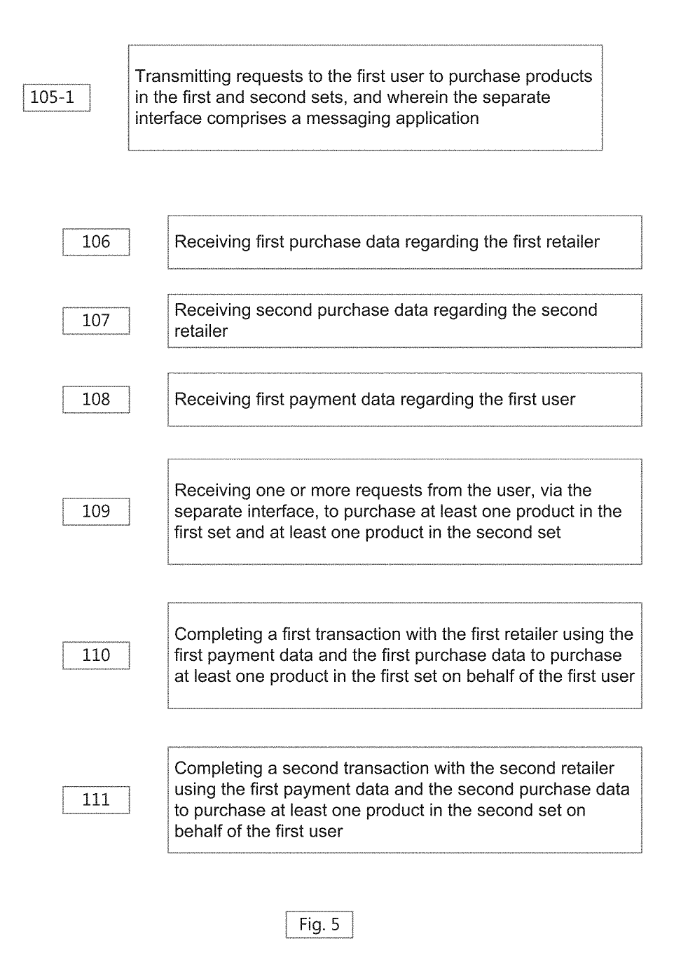

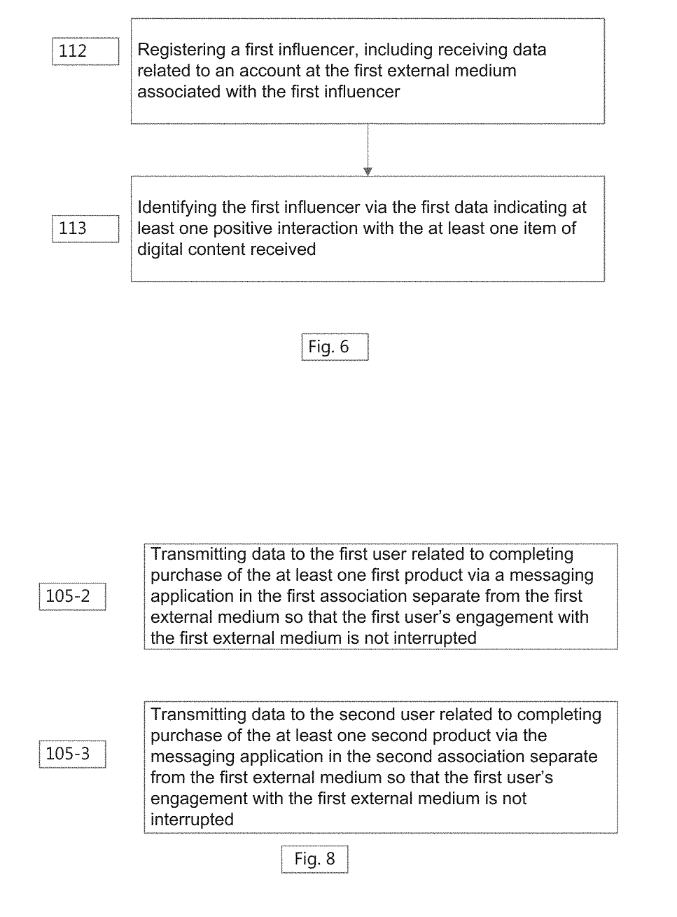

FIG. 5 shows additional detail regarding the step of transmitting data related to purchase in instances in which products from multiple retailers are associated with an item of digital content, as well as steps related to completing the purchase. At step 105-1, the system transmits requests to the first user to purchase products in the first and second sets, identified in steps 101-1 and 101-2, where the separate interface comprises a messaging application. At steps 106 and 107, the system receives first and second purchase data regarding the first and second retailers, respectively. At step 108, the system receives first payment data regarding the first user. At step 109, the system receives one or more requests from the user, via the separate interface, to purchase at least one product in the first set and at least one product in the second set. At step 110, the system completes a first transaction with the first retailer using the first payment data and the first purchase data to purchase at least one product in the first set on behalf of the first user. At step 111, the system completes a second transaction with the second retailer using the first payment data and the second purchase data to purchase at least one product in the second set on behalf of the first user.

In this embodiment, completion of purchase transactions is performed by a cart service. In some embodiments, if a user elects to purchase one or more of the products of interest, data relating to the variants and quantities to be purchased is received from the user by the messaging service, which passes the information to the cart service, which will assemble the order.

In this embodiment, the cart service retrieves the user information from the user profile service regarding the user's payment, billing, and shipping information, which was provided by the user when registering with the system or at a later time. The cart service is able to access the retailers' order systems, enabling it to update existing orders and/or create new ones.

The cart service retrieves the tax and shipping costs from the internal admin tool for each retailer involved. In some embodiments, the cart service also does a final stock check with the E- commerce platform API(s). The cart service then calculates an estimated total for the order which could comprise multiple products from multiple retailers. In some embodiments, the user is sent confirmation of the total cost via the messaging service. If the user confirms the cost, he or she is presented with a payment confirmation message and is able to confirm the payment amount and authorize the payment.

In this embodiment, the cart service then communicates with the payment system API to authorize and take payment. If the payment is successful, the user is notified via the messaging service and the cart service will create individual orders for all retailers included in the transaction via the E-commerce platform API. In some embodiments, the user will receive confirmation notifications from the messaging service regarding completion of the transactions. In other embodiments, the user will receive confirmation notifications from each of the individual retailers involved in the transaction. In some embodiments, all of the data of the transaction is stored in the data analytic service which provides transaction history as well as the engagement around the interactions.

The cart service assists users in completing multiple transactions in what appears to the user to be a single transaction.

FIG. 6 shows additional steps 112 and 113 performed by the system related to the interaction of influencers with the system. At step 112, the system registers a first influencer, including receiving data related to an account at the first external medium associated with the first influencer. At step 113, the system identifies the first influencer via the first data indicating at least one positive interaction with the at least one item of digital content received. In some embodiments, influencers engage with an influencer admin tool to register any external media accounts they wish to use in conjunction with the system. This registration allows the system access to the influencer's posts and/or publications of any digital content to those external media. The system achieves this by engaging with the API of any registered external media. The influencer admin tool also enables influencers to create the “looks” described above. In embodiments in which an influencer has created multiple looks, the influencer is identified by the system in conjunction with positive interactions with all such looks.

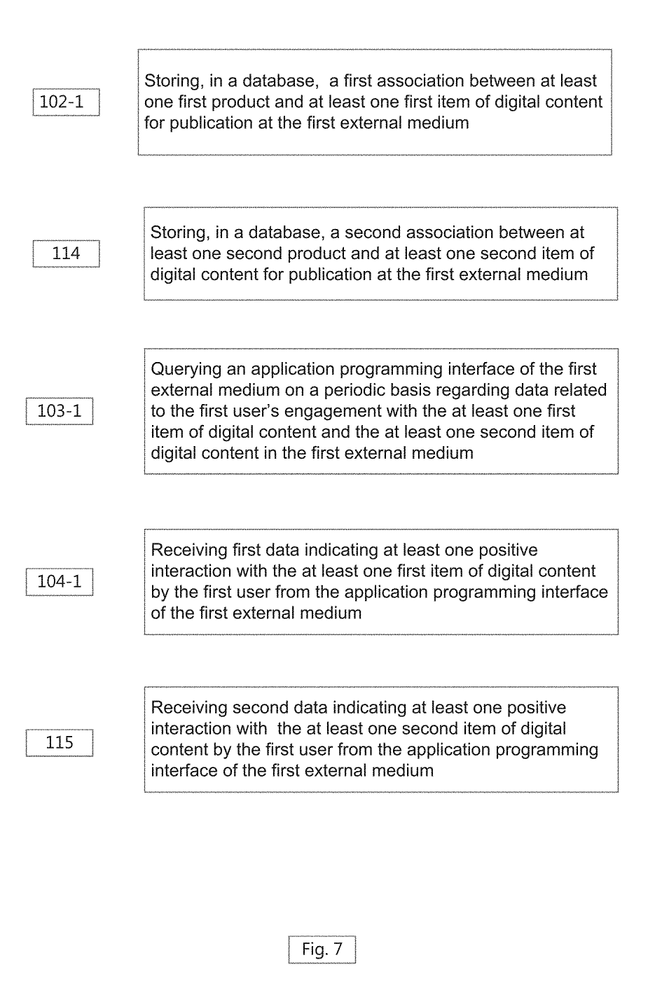

FIG. 7 shows additional steps related to creating multiple associations. At step 102-1, the system stores, in a database, a first association between at least one first product and at least one first item of digital content for publication at the first external medium. At step 114, the system stores, in a database, a second association between at least one second product and at least one second item of digital content for publication at the first external medium. At step 103-1, the system queries an application programming interface of the first external medium on a periodic basis regarding data related to the first user's engagement with the at least one first item of digital content and the at least one second item of digital content in the first external medium. At step 104-1, the system receives first data indicating at least one positive interaction with the at least one first item of digital content by the first user from the application programming interface of the first external medium. At step 115, the system receives second data indicating at least one positive interaction with the at least one second item of digital content by the first user from the application programming interface of the first external medium.

FIG. 8 shows additional detail regarding the step of transmitting data to the first user when the user has indicated acceptance of more than one item of digital content, or multiple associations in continuation of FIG. 7. At step 105-2, the system transmits data to the first user related to completing purchase of the at least one first product via a messaging application in the first association separate from the first external medium so that the first user's engagement with the first external medium is not interrupted. At step 105-3, the system transmits data to the second user related to completing purchase of the at least one second product via the messaging application in the second association separate from the first external medium so that the first user's engagement with the first external medium is not interrupted.

The system, therefore, permits users to shop for products promoted via various external media without disrupting the users' desired engagement with that media. The system tracks the user's acceptance and other interactions with product promotions and engages the user outside of the traditional avenue for completing the purchase transaction. The system also enables users to purchase from multiple brands in what appears to be from the user's perspective, a single transaction. The system handles interaction with multiple payment systems as necessary when a user wishes to purchase products from multiple retailers that have been combined in a look or association.

On the influencer side, the system streamlines the manner in which the influencer can earn revenue from multiple retailers simultaneously, in some circumstances. By enabling the influencer to create single looks or associations that include products from any number of retailers, the influencer has greater flexibility in creating attractive looks without any added complexity in the logistics or accounting.

On the retailer side, the system provides more opportunities to make sales via the reduced friction experienced by the users and influencers. The retailers and influencers also benefit from the data gathered by the system related to user engagement analytics. The system data analytics tools permit review of engagement analytics, such as product popularity and influencer popularity, all order histories, affiliate earnings, and any other relevant analysis of the data gathered by the system.

The system also provides analytics able to identify groups of influencers and consumers by geolocation, profile information, purchase history, human physical characteristic so as to facilitate communication via the messaging service to exchange content. This is facilitated by authorized access to the store admin tool.

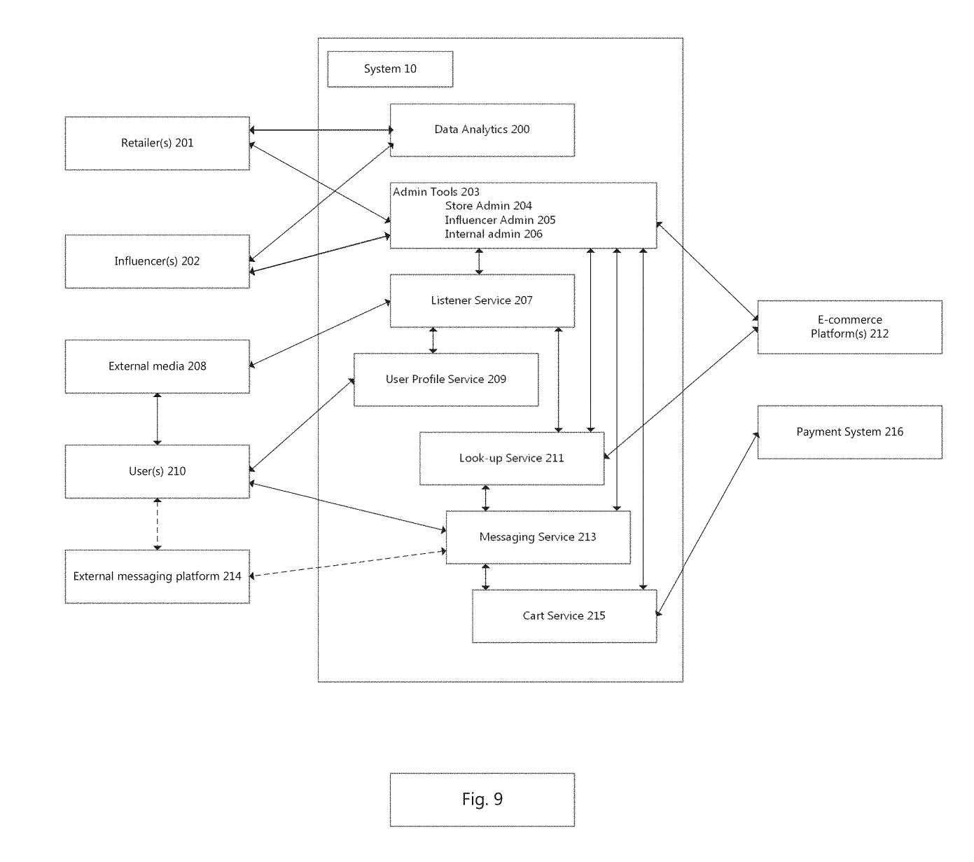

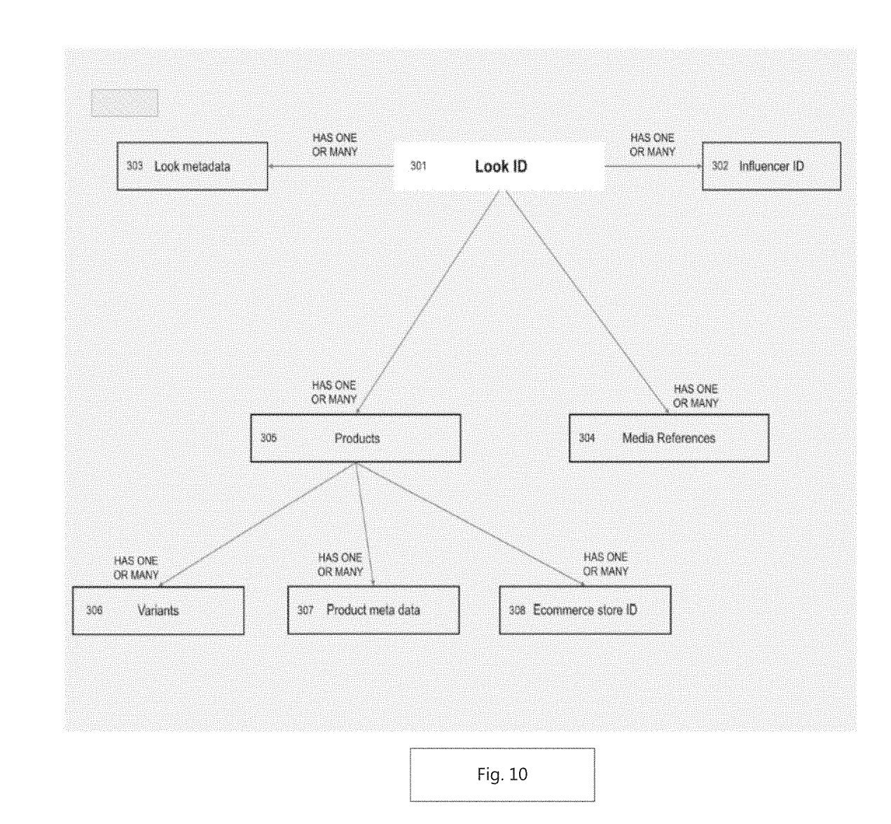

FIG. 9 shows the communication links and relationships between the system and the various entities involved in one advantageous embodiment of the present invention. The system 10 includes the various services described herein, each typically embodied as one or more software modules. These include the data analytics module 200, which is typically in communication with both retailers 201 and influencers 202. System admin tools 203 includes store admin 204, through which retailers set up products to sell through the system, influencer admin 205, through which influencers 202 register and create and save “looks”, and internal admin 206, which allows the system to administer its various tasks. The admin tools 203 receive product information from one or more E-commerce platform(s) 212. The system's admin tools 203 communicate with the listener service 207, which stores look/association data and which monitors external media 208. The admin tools 203 also communicate with the look-up service 211, messaging service 213, and cart service 215 to provide product data, as well as all necessary information regarding users, influencers, and retailers.

The listener service 207 also receives user registration data from the user profile service 209, which users 201 use to register with the system. The look-up service 211 receives data from the listener service 207 in order to monitor and check product data at the E-commerce platform 212. The look-up service 211 serves data to the messaging service 213, which is used to communicate with the users 210 regarding product purchase, either directly or via external messaging platforms 214. Finally, the messaging service 213 provides data to the cart service 215 for completion of product purchase transactions on behalf of the users 210. The cart service 215 is adapted to engage with one or more payment systems 216 in order to pay retailers.

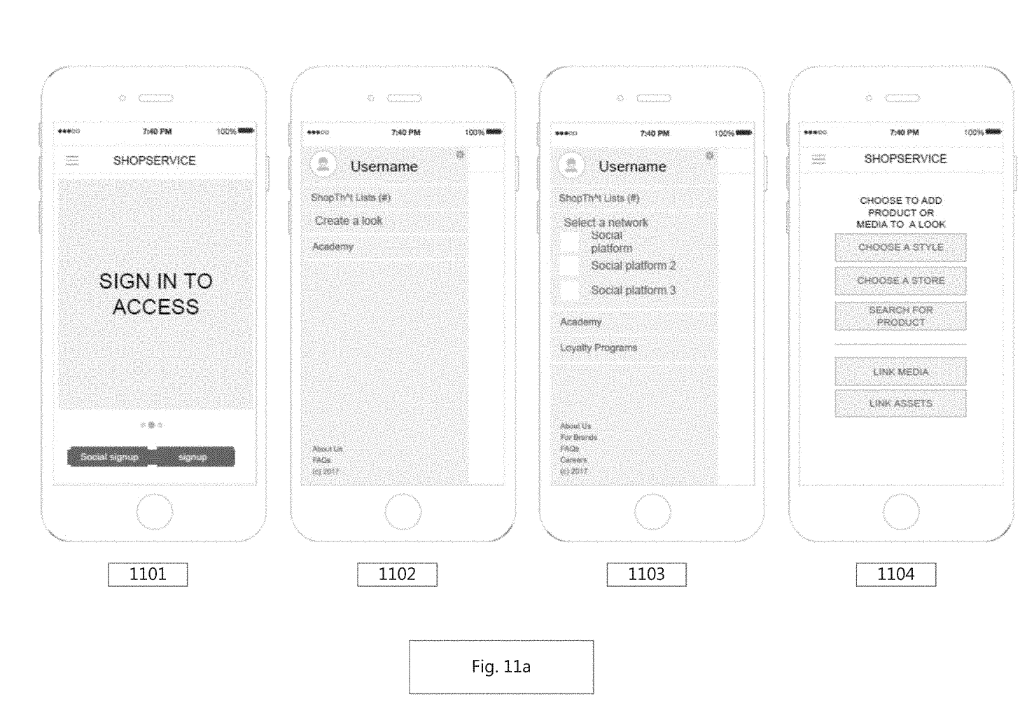

FIG. 10 shows a schematic view of the components of “look” or association created for use in the system. A Look ID (301) refers to the object stored by the system at the request of an influencer (as described above). The Look ID 301 includes one or more associations created between various types of information. A single Look ID 301 can be connected to many influencers 302, and many metadata points (303) which may include additional purchasable links, products, and items of digital content. The Look

ID (301) can be connected to many media references (304), which includes items of digital content. The look is also connected to many products (305), which may come from an internal or external E-commerce API, and may have many variants (306), price, description, and other metadata (307), as well as an ecommerce store ID (308).

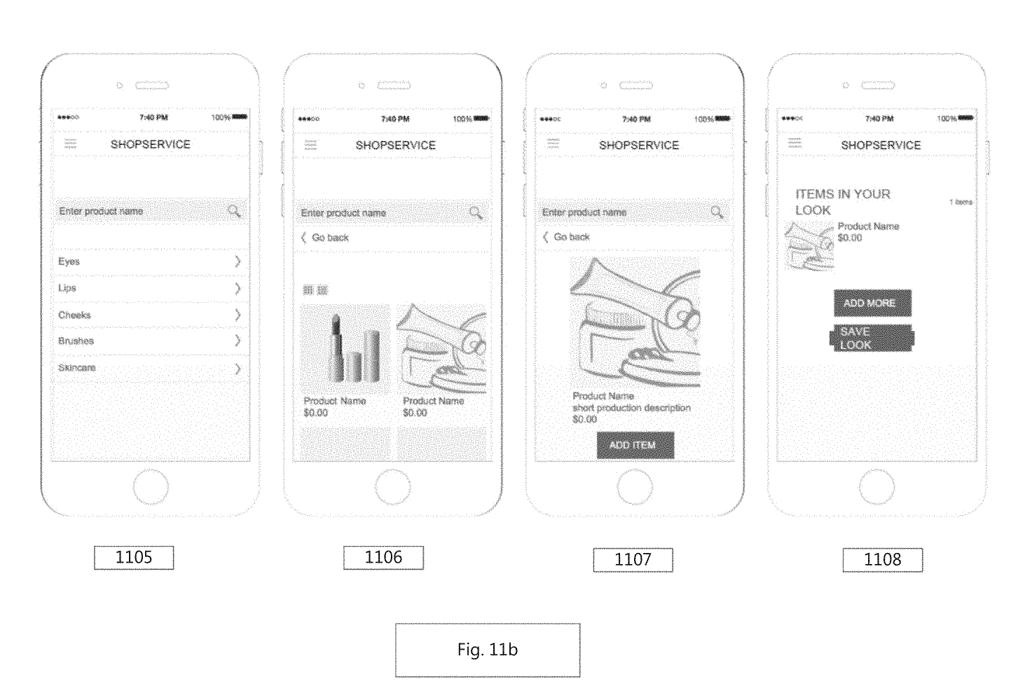

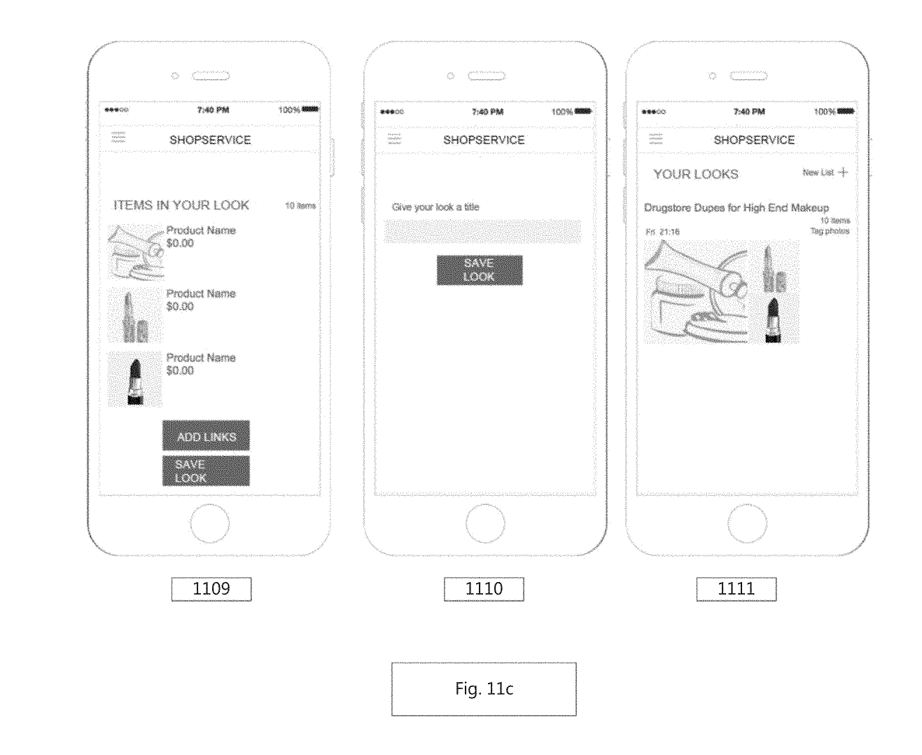

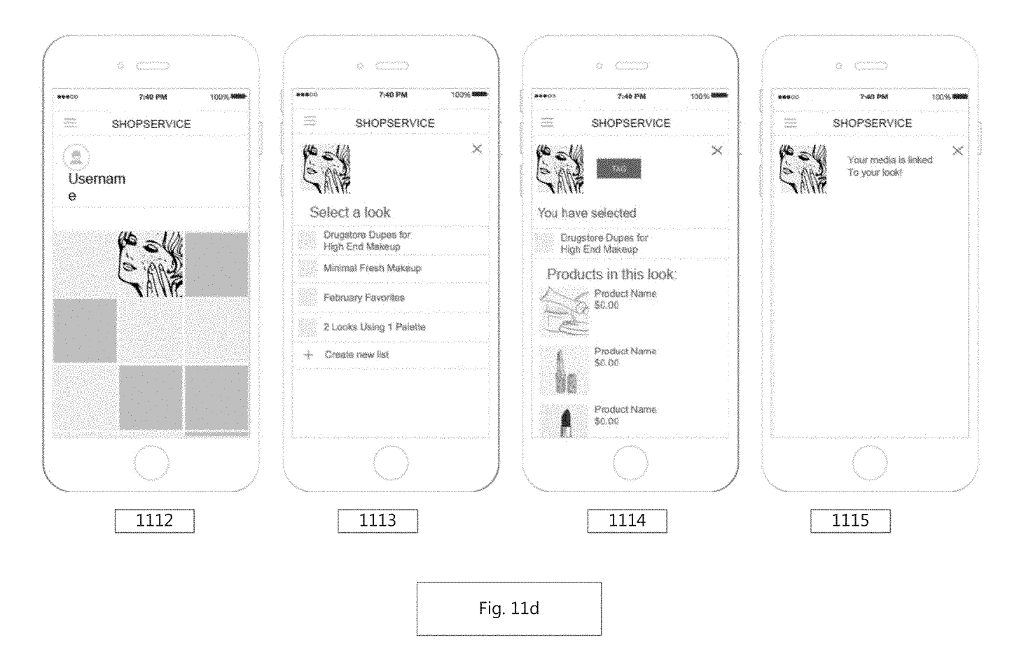

FIGS. 11a-11b show a series of screen shots of an application interface by which influencers interact with a system according to an embodiment of the invention. The application is configured for use on a smartphone in the embodiment shown, but, in other embodiments, is configured for use on tablets, laptop PCs, desktop PCs, web browsers, etc. The interface allows influencers to link digital content to products, services, and/or experiences and associated metadata for use on external media.

The login screen (1101) allows influencers to log in with their external media credentials, such as, social media and internet platform credentials, including Instagram, YouTube, Google, Facebook, Pinterest or Snapchat, as discussed above. After successful authentication (1102) influencers are presented with a menu of options through which to access the system. Selecting “Create a look” begins the process of creating the association(s) between digital content and products that are stored by the system. The first step, in this embodiment, is for the influencer to select (1103), via “Select a network” whichever external media (e.g., “Social platform,” “Social platform 2,” “Social platform 3” in the figure) they intend to utilize. After choosing one or more external media, influencers, then are able to choose a retailer (1104) whose products they would like to link.

FIG. 11b shows that, after selecting a retailer, the system allows the influencer to find products, services or experiences from that e-commerce store (1105). The menu system from the retailer is displayed or the influencer can search for product by name or other unique identifier. Searching for a product (1106) will display products, services or experiences from that retailer (or the user themselves) in various grid style views. Displayed with the product is the product price and image, which are pulled from the e-commerce API. Selecting a product brings the influencer to the product page (1107) where they can find additional imagery, metadata and product data. The influencer can select to “add item.” This will add that product to the look (i.e., associate it with the Look ID), and bring the influencer to the list page (1108). From here the influencer can see the products, services or experiences in the look, add more products, services or experiences or save the look.

As shown in FIG. 11c, the influencer can review (1109) and add additional items to the look from multiple retailers and the influencer can edit and change the items. When the influencer selects “save look” they are required to name the list (1110), which then automatically brings the influencer to a view of all Looks (1111) of all the looks they have created.

As shown in FIG. 11d, influencers are then be able to view digital content on any external media or stored on any device (1112). They are able to associate one or many items of digital content with a Look (1113). Influencers have the ability to preview the products, services or experiences and content in a Look that they will associate with an item of digital content (1114) before saving, the system will provide confirmation that the Look is associated with the content (1115).

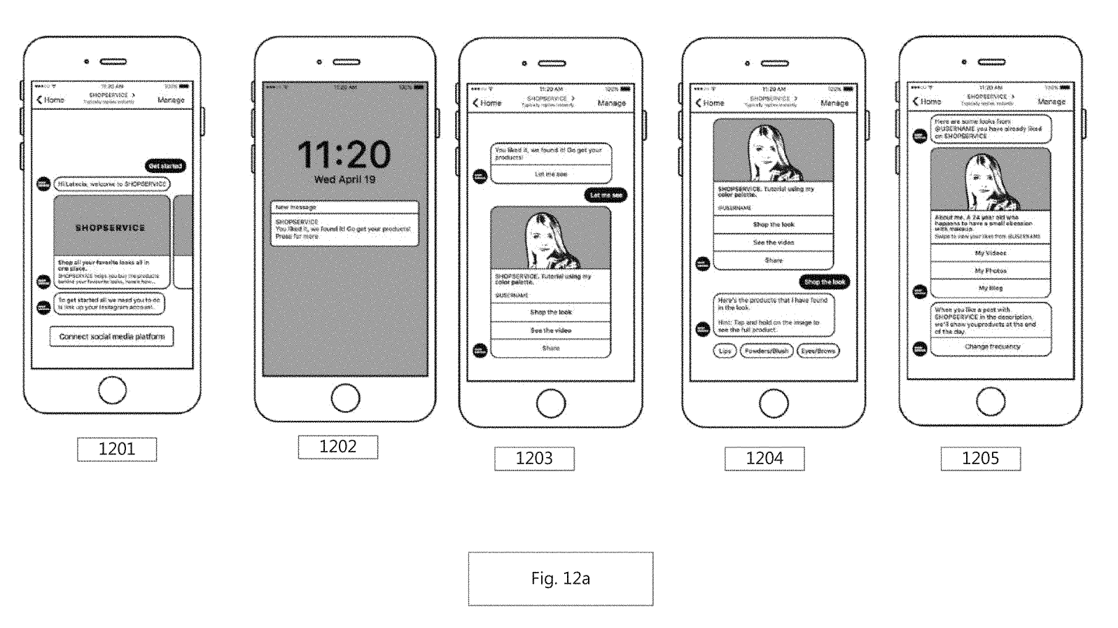

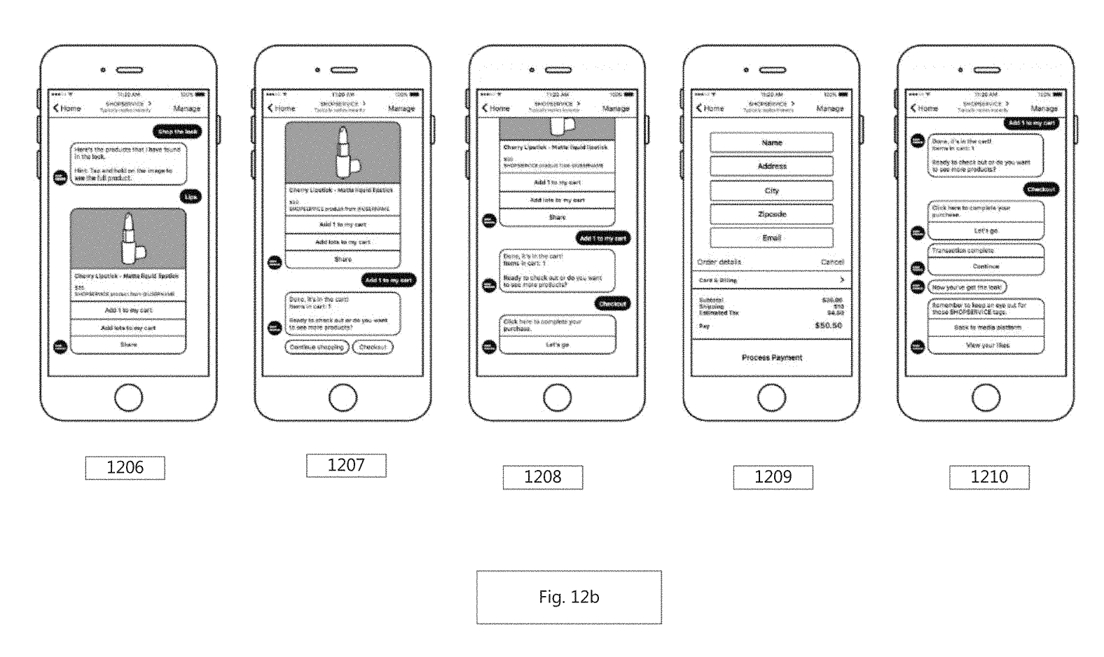

FIGS. 12a-12b show a series of screen shots of an interface through which users interact with a system according to an embodiment of the invention. FIG. 12a shows an exemplary start page in a messaging application to which a user is driven (1201) from various sources. These include paid advertising, search, links or some other kind of digital means. This application allows the user to connect one or many external media to their account, for example Instagram. In this embodiment, the system sends a message via an electronic message system, either in text, voice or other digital communication means, (1202) regarding digital content and/or products that the user has interacted with. When the user opens the message (1203), they are able to view media and content which presents itself to them in a list form. Users are able to view associated media corresponding to the media they have just received. Products are included in the post, which allow the user to select to add products to the cart. There is an option to choose from a menu or grouping of products (1204). In some embodiments, the messaging system provides a means to view products that the user has, in the past, interacted with (1205).

As shown in FIG. 12b, a list view of products (1206) will be displayed in which users can choose a variant or variants of that product, choose a quantity and add to a cart (1207), as well as share that product and content. Users are able to checkout (1208) and purchase the item, first by confirming the basket, then by adding or retrieving their name, shipping details as well as collection of payment of the item to be fulfilled by the retailer (1209). After the purchase, the system sends a notification allowing them to view additional content or resources (1210).

Although the invention has been described with reference to a particular arrangement of parts, features and the like, these are not intended to exhaust all possible arrangements or features, and indeed many modifications and variations will be ascertainable to those of skill in the art.

What is claimed is:

1. A computer implemented method practiced on a set of one or more devices, each comprising at least one processor, the method comprising:
registering a first user, including receiving data to permit monitoring engagement with a first external medium by an account of the first user at the first external medium;
receiving product data regarding a set of one or more products from one or more retailers;
storing, in a database, an association between at least one product from the set of one or more products and at least one item of digital content for publication on the first external medium;
querying an application programming interface of the first external medium on a periodic basis regarding data related to a first user's engagement with the at least one item of digital content on the first external medium;
receiving, from the application programming interface of the first external medium, first data indicating at least one positive interaction with the at least one item of digital content by the first user; and
transmitting data to the first user related to completing purchase of the at least one product from the set of one or more products in the association via an interface separate from the first external medium so that the first user's engagement with the first external medium is not interrupted.

2. The method of claim 1, wherein the step of receiving product data comprises:
receiving first product data regarding a first set of one or more products from a first retailer; and
receiving second product data regarding a second set of one or more products from a second retailer;
and wherein the step of storing an association comprises:
storing a first association between the first product data and the second product data to form a first look; and
storing a second association between the first look and the at least one item of digital content.

3. The method of claim 2, wherein the step of transmitting data to the first user related to completing purchase further comprises transmitting requests to the first user to purchase products in the first and second sets, and wherein the separate interface comprises a messaging application; and
wherein the method further comprises:
receiving first purchase data regarding the first retailer;
receiving second purchase data regarding the second retailer;
receiving first payment data regarding the first user;
receiving one or more requests from the user, via the separate interface, to purchase at least one product in the first set and at least one product in the second set;
completing a first transaction with the first retailer using the first payment data and the first purchase data to purchase at least one product in the first set on behalf of the first user; and
completing a second transaction with the second retailer using the first payment data and the second purchase data to purchase at least one product in the second set on behalf of the first user.

4. The method of claim 2, further comprising the steps of:
registering a first influencer, including receiving data related to an account at the first external medium associated with the first influencer;
identifying the first influencer via the first data indicating at least one positive interaction with the at least one item of digital content received.

5. The method of claim 1, wherein the step of creating an association comprises:
storing, in a database, a first association between at least one first product and at least one first item of digital content for publication at the first external medium;
and the method further comprises the step of:
storing, in a database, a second association between at least one second product and at least one second item of digital content for publication at the first external medium;
wherein the step of querying an application programming interface comprises:
querying an application programming interface of the first external medium on a periodic basis regarding data related to the first user's engagement with the at least one first item of digital content and the at least one second item of digital content in the first external medium;
wherein the step of receiving first data indicating acceptance of the at least one first item of digital content comprises:
receiving first data indicating at least one positive interaction with the at least one first item of digital content by the first user from the application programming interface of the first external medium; and
wherein the method further comprises the step of:
receiving second data indicating at least one positive interaction with the at least one second item of digital content by the first user from the application programming interface of the first external medium.

6. The method of claim 5, wherein the step of transmitting data to the first user related to completing purchase further comprises:
transmitting data to the first user related to completing purchase of the at least one first product via a messaging application in the first association separate from the first external medium so that the first user's engagement with the first external medium is not interrupted; and
transmitting data to the second user related to completing purchase of the at least one second product via the messaging application in the second association separate from the first external medium so that the first user's engagement with the first external medium is not interrupted.

7. The method of claim 5, further comprising the steps of:
registering a first influencer, including receiving data related to an account at the first external medium associated with the first influencer;
identifying the first influencer via the first data indicating at least one positive interaction with the at least one first item of digital content received and/or via the second data indicating at least one positive interaction with the at least one second item of digital content received.

8. A system, comprising:
a set of one or more processors;
a computer-readable medium storing instructions executable by the set of one or more processors to perform operations comprising:
registering a first user, including receiving data to permit monitoring engagement with a first external medium by an account of the first user at the first external medium;
receiving product data regarding a set of one or more products from one or more retailers;
storing, in a database, an association between at least one product from the set of one or more products and at least one item of digital content for publication on the first external medium;
querying an application programming interface of the first external medium on a periodic basis regarding data related to a first user's engagement with the at least one item of digital content on the first external medium;
receiving, from the application programming interface of the first external medium, first data indicating at least one positive interaction with the at least one item of digital content by the first user; and
transmitting data to the first user related to completing purchase of the at least one product from the set of one or more products in the association via an interface separate from the first external medium so that the first user's engagement with the first external medium is not interrupted.

9. The system of claim 8, wherein the operation of receiving product data comprises:
receiving first product data regarding a first set of one or more products from a first retailer; and
receiving second product data regarding a second set of one or more products from a second retailer;
and wherein the operation of storing an association comprises:
storing a first association between the first product data and the second product data to form a first look; and
storing a second association between the first look and the at least one item of digital content.

10. The system of claim 9, wherein the operation of transmitting data to the first user related to completing purchase further comprises transmitting requests to the first user to purchase products in the first and second sets, and wherein the separate interface comprises a messaging application; and
wherein the system further comprises instructions for:
receiving first purchase data regarding the first retailer;
receiving second purchase data regarding the second retailer;
receiving first payment data regarding the first user;
receiving one or more requests from the user, via the separate interface, to purchase at least one product in the first set and at least one product in the second set;
completing a first transaction with the first retailer using the first payment data and the first purchase data to purchase at least one product in the first set on behalf of the first user; and
completing a second transaction with the second retailer using the first payment data and the second purchase data to purchase at least one product in the second set on behalf of the first user.

11. The system of claim 9, further comprising instructions for:
registering a first influencer, including receiving data related to an account at the first external medium associated with the first influencer;
identifying the first influencer via the first data indicating at least one positive interaction with the at least one item of digital content received.

12. The system of claim 8, wherein the operation of creating an association comprises:
storing, in a database, a first association between at least one first product and at least one first item of digital content for publication at the first external medium;
and the system further comprises instructions for:
storing, in a database, a second association between at least one second product and at least one second item of digital content for publication at the first external medium;
wherein the operation of querying an application programming interface comprises:
querying an application programming interface of the first external medium on a periodic basis regarding data related to the first user's engagement with the at least one first item of digital content and the at least one second item of digital content in the first external medium;
wherein the operation of receiving first data indicating acceptance of the at least one first item of digital content comprises:
receiving first data indicating at least one positive interaction with the at least one first item of digital content by the first user from the application programming interface of the first external medium; and
wherein the system further comprises instructions for:
receiving second data indicating at least one positive interaction with the at least one second item of digital content by the first user from the application programming interface of the first external medium.

13. The system of claim 12, wherein the operation of transmitting data to the first user related to completing purchase further comprises:
transmitting data to the first user related to completing purchase of the at least one first product via a messaging application in the first association separate from the first external medium so that the first user's engagement with the first external medium is not interrupted; and
transmitting data to the second user related to completing purchase of the at least one second product via the messaging application in the second association separate from the first external medium so that the first user's engagement with the first external medium is not interrupted.

14. The system of claim 12, further comprising instructions for:
registering a first influencer, including receiving data related to an account at the first external medium associated with the first influencer;
identifying the first influencer via the first data indicating at least one positive interaction with the at least one first item of digital content received and/or via the second data indicating at least one positive interaction with the at least one second item of digital content received.

15. A non-transitory computer-readable medium, storing instructions executable by a set of one or more processors to perform operations comprising:
registering a first user, including receiving data to permit monitoring engagement with a first external medium by an account of the first user at the first external medium;
receiving product data regarding a set of one or more products from one or more retailers;
storing, in a database, an association between at least one product from the set of one or more products and at least one item of digital content for publication on the first external medium;
querying an application programming interface of the first external medium on a periodic basis regarding data related to a first user's engagement with the at least one item of digital content on the first external medium;
receiving, from the application programming interface of the first external medium, first data indicating at least one positive interaction with the at least one item of digital content by the first user; and
transmitting data to the first user related to completing purchase of the at least one product from the set of one or more products in the association via an interface separate from the first external medium so that the first user's engagement with the first external medium is not interrupted.

16. The medium of claim 15, wherein the operation of receiving product data comprises:
receiving first product data regarding a first set of one or more products from a first retailer; and
receiving second product data regarding a second set of one or more products from a second retailer;
and wherein the operation of storing an association comprises:
storing a first association between the first product data and the second product data to form a first look; and
storing a second association between the first look and the at least one item of digital content.

17. The medium of claim 16, wherein the operation of transmitting data to the first user related to completing purchase further comprises transmitting requests to the first user to purchase products in the first and second sets, and wherein the separate interface comprises a messaging application; and
wherein the medium further comprises instructions for:
receiving first purchase data regarding the first retailer;
receiving second purchase data regarding the second retailer;
receiving first payment data regarding the first user;
receiving one or more requests from the user, via the separate interface, to purchase at least one product in the first set and at least one product in the second set;
completing a first transaction with the first retailer using the first payment data and the first purchase data to purchase at least one product in the first set on behalf of the first user; and
completing a second transaction with the second retailer using the first payment data and the second purchase data to purchase at least one product in the second set on behalf of the first user.

18. The medium of claim 17, further comprising instructions for:
registering a first influencer, including receiving data related to an account at the first external medium associated with the first influencer;
identifying the first influencer via the first data indicating at least one positive interaction with the at least one item of digital content received.

19. The medium of claim 15, wherein the operation of creating an association comprises:
storing, in a database, a first association between at least one first product and at least one first item of digital content for publication at the first external medium;
and the medium further comprises instructions for:
storing, in a database, a second association between at least one second product and at least one second item of digital content for publication at the first external medium;
wherein the operation of querying an application programming interface comprises:
querying an application programming interface of the first external medium on a periodic basis regarding data related to the first user's engagement with the at least one first item of digital content and the at least one second item of digital content in the first external medium;
wherein the operation of receiving first data indicating acceptance of the at least one first item of digital content comprises:
receiving first data indicating at least one positive interaction with the at least one first item of digital content by the first user from the application programming interface of the first external medium; and
wherein the medium further comprises instructions for:
receiving second data indicating at least one positive interaction with the at least one second item of digital content by the first user from the application programming interface of the first external medium.

20. The medium of claim 19, wherein the operation of transmitting data to the first user related to completing purchase further comprises:
transmitting data to the first user related to completing purchase of the at least one first product via a messaging application in the first association separate from the first external medium so that the first user's engagement with the first external medium is not interrupted; and
transmitting data to the second user related to completing purchase of the at least one second product via the messaging application in the second association separate from the first external medium so that the first user's engagement with the first external medium is not interrupted.

21. The medium of claim 19, further comprising instructions for:
registering a first influencer, including receiving data related to an account at the first external medium associated with the first influencer;
identifying the first influencer via the first data indicating at least one positive interaction with the at least one first item of digital content received and/or via the second data indicating at least one positive interaction with the at least one second item of digital content received.
